(19) United States
(12) Patent Application Publication
(10) Pub. No.: US 2019/0198897 A1
(43) Pub. Date: Jun. 27, 2019

(54) FUEL CELL SYSTEM AND CONTROL METHOD THEREOF

(71) Applicant: HONDA MOTOR CO., LTD., Tokyo (JP)

(72) Inventors: Yuji Okamura, Wako-shi (JP); Koichi Takaku, Wako-shi (JP); Koichi Kato, Wako-shi (JP)

(21) Appl. No.: 16/226,776

(22) Filed: Dec. 20, 2018

(30) Foreign Application Priority Data
Dec. 21, 2017 (JP) 2017-245122

(51) Int. Cl. H01M 8/04223; H01M 8/04302; H01M 8/0258; H01M 8/04014; H01M 8/0267

(52) U.S. Cl. CPC H01M 8/04268; H01M 8/04302; H01M 8/0258; H01M 8/0432; H01M 8/0267; H01M 8/04253; H01M 8/04022

(57) ABSTRACT

A fuel cell system includes a gas-liquid separator, a circulation flow path, a connecting flow path, and a distribution flow path. The gas-liquid separator separates fuel exhaust gas, which flows therein via a fuel exhaust gas flow path, into a gas and a liquid. The circulation flow path causes a gas discharge port of the gas-liquid separator and the fuel gas supply flow path to be in communication with each other. The connecting flow path causes a liquid discharge port of the gas-liquid separator to be in communication with the oxygen-containing gas supply flow path, via a drain valve. The distribution flow path causes the fuel gas supply flow path or the circulation flow path to be in communication with the oxygen-containing gas supply flow path, via an opening and closing valve.

### CROSS-REFERENCE TO RELATED APPLICATION

This application is based upon and claims the benefit of priority from Japanese Patent Application No. 2017-245122 filed on Dec. 21, 2017, the contents of which are incorporated herein by reference.

### BACKGROUND OF THE INVENTION

### Field of the Invention

The present invention relates to a fuel cell system that generates electric power by supplying fuel gas and oxygen-containing gas to an anode and a cathode of a fuel cell, and also relates to a control method of the fuel cell system.

### Description of the Related Art

As an example, a solid polymer type of fuel cell includes an electrolyte electrode assembly, e.g., a membrane electrode assembly (MEA), in which an anode is arranged on one surface of an electrolyte membrane formed from a polymer ion exchange membrane and a cathode is arranged on the other surface of the electrolyte membrane. The membrane electrode assembly is sandwiched by separators to form a power generation cell (single cell). Usually, a certain number of power generation cells needed to obtain a desired amount of power generation are stacked, and incorporated in a fuel cell vehicle or the like, for example, in a stacked state.

With this type of fuel cell, the optimal operational temperature range for power generation is approximately 70° C. to 100° C., for example, and particularly when used in a vehicle or the like, it is believed that this fuel cell would be started in a cold environment at a temperature below freezing or the like. In this case, the speed of the power generation reaction in the fuel cell drops according to how low the temperature is, and there are cases where it takes a long time for the fuel cell to reach the optimal operational temperature range using only the heating caused by this power generation reaction. Therefore, in order to quickly warm up the fuel cell to the operational temperature range described above even when starting up at a temperature below freezing or the like, a method is proposed for low-temperature start-up of a fuel cell system in Japanese Laid-Open Patent Publication No. 2001-189164, for example. With this method, oxygen-containing gas is supplied to a cathode and fuel gas is supplied from a fuel gas supply apparatus, to cause an exothermic reaction in a cathode catalyst.

### SUMMARY OF THE INVENTION

The main object of the present invention is to provide a fuel cell system that can quickly warm up a fuel cell by effectively using discharge fluid, when a drain valve for discharging the discharge fluid from a liquid discharge port of a gas-liquid separator into which fuel exhaust gas flows is opened correctly.

Another object of the present invention is to provide a control method for this fuel cell system.

According to a first aspect of the present invention, there is provided a fuel cell system for generating electric power by supplying fuel gas to an anode of a fuel cell via a fuel gas supply flow path and supplying an oxygen-containing gas to a cathode of the fuel cell via an oxygen-containing gas supply flow path, the fuel cell system including a fuel exhaust gas flow path configured to allow fuel exhaust gas discharged from the anode to flow therethrough, a gas-liquid separator into which the fuel exhaust gas flows via the fuel exhaust gas flow path, the gas-liquid separator being configured to separate the fuel exhaust gas into a gas and a liquid, a circulation flow path that is connected to the fuel gas supply flow path via a connecting section so as to cause a gas discharge port of the gas-liquid separator and the fuel gas supply flow path to be in communication with each other, a connecting flow path configured to cause a liquid discharge port of the gas-liquid separator to be in communication with the oxygen-containing gas supply flow path, via a drain valve, a distribution flow path configured to cause the fuel gas supply flow path or the circulation flow path to be in communication with the oxygen-containing gas supply flow path, and an opening and closing valve configured to open and close the distribution flow path.

In this fuel cell system, an electrochemical reaction (power generation reaction) is caused by supplying the fuel gas to the anode and supplying the oxygen-containing gas to the cathode. As a result, the fuel exhaust gas is discharged from the anode to the fuel exhaust gas flow path. This fuel exhaust gas contains an unconsumed portion of fuel gas that was not consumed in the power generation reaction (referred to below simply as an unconsumed portion), excess water, and the like. Accordingly, by causing the fuel exhaust gas to flow into the gas-liquid separator via the fuel exhaust gas flow path, the discharge gas containing the unconsumed portion and having its liquid water separated is discharged from the gas discharge port to the circulation flow path. The circulation flow path is connected to the fuel gas supply flow path via the connecting portion. Therefore, the unconsumed portion can be supplied again to the anode via the circulation flow path and the fuel gas supply flow path to be used in the power generation reaction.

On the other hand, since the liquid discharge port of the gas-liquid separator is connected to the connecting flow path via the drain valve, by opening the drain valve, the discharge fluid containing the unconsumed portion and the liquid water is discharged from this liquid discharge port to the connecting flow path. In this way, by causing the unconsumed portion contained in the discharge fluid to flow into the oxygen-containing gas supply flow path, this unconsumed portion can be supplied along with the oxygen-containing gas to the cathode. Due to this, the exothermic reaction in the cathode catalyst can be caused.

Accordingly, since the fuel cell can be heated by the heat of the exothermic reaction in the cathode catalyst as well as by the heat of the power generation reaction described above, it is possible to quickly warm up the fuel cell. Furthermore, in normal cases, the unconsumed portion contained in the discharge fluid released into the atmosphere or the like can be efficiently utilized, and therefore it is possible to increase the usage efficiency of the fuel gas supplied to the fuel cell system. In this case, it is also possible to remove the need for equipment for diluting the unconsumed portion contained in the discharge fluid, or the like before being vented to atmosphere.

Furthermore, even in a case where the drain valve does not open correctly due to freezing or the like, for example, and the unconsumed portion contained in the discharge fluid cannot be supplied to the cathode, by opening the opening and closing valve, the fuel gas supply flow path or circulation flow path comes into communication with the oxygen-containing gas supply flow path, via the distribution flow path. Due to this, instead of the discharge fluid, the fuel gas contained in any one of the fuel gas supplied to the fuel gas supply flow path, the discharge gas, and the mixture of these gases is supplied along with the oxygen-containing gas to the cathode, and the exothermic reaction can be caused in the cathode catalyst. Accordingly, even if the drain valve does not open correctly, it is possible to quickly warm up the fuel cell.

In the fuel cell system described above, it is preferable that the connecting section is provided with an ejector configured to mix together the fuel gas supplied to the fuel gas supply flow path and discharge gas discharged from the gas discharge port to the circulation flow path, the ejector is supplied with the fuel gas via a solenoid valve, and the distribution flow path causes a portion of the fuel gas supply flow path farther downstream than the ejector to be in communication with the oxygen-containing gas supply flow path.

In this case, when the opening and closing valve is opened, the mixed gas on the downstream side of the ejector flows through the oxygen-containing gas supply flow path via the distribution flow path, and therefore the solenoid valve provided on the upstream side of the ejector increases the flow rate of the fuel gas ejected by this ejector. Due to this, the suction force exerted on the discharge gas by the ejector increases, and therefore it is possible to improve the circulation efficiency of the circulated gas that is circulated through the downstream side of the ejector in the fuel gas supply flow path, the fuel exhaust gas flow path, and the circulation flow path, without using a pump or the like. As a result, the power generation reaction is encouraged with a simple configuration, and it is possible to quickly warm up the fuel cell.

In the fuel cell system described above, it is preferable that a control unit configured to issue valve opening instructions or valve closing instructions to the opening and closing valve and the drain valve is further included, and that the control unit issues the valve opening instructions to the drain valve when a warm-up of the fuel cell begins. When the drain valve opens in response to these valve opening instructions, the discharge fluid can be effectively used to quickly warm up the fuel cell.

In the fuel cell system described above, it is preferable that the control unit issues the valve opening instructions to the opening and closing valve if it is judged that the drain valve to which the valve opening instructions have been issued is not open. In this case, instead of the discharge fluid, the fuel gas contained in any one of the fuel gas supplied to the fuel gas supply flow path, the discharge gas, and the mixture of these gases can be used to quickly warm up the fuel cell.

In the fuel cell system described above, it is preferable that a pressure sensor configured to detect pressure of gas circulating through a portion of the fuel gas supply flow path farther downstream than the connecting section, the fuel exhaust gas flow path, and the circulation flow path is further included, and that the control unit judges whether the drain valve to which the valve opening instructions have been issued is open, based on a detection result of the pressure sensor. In this way, by basing this judgment on the detection results of the pressure sensor, it is possible to judge as to whether the drain valve is actually open, easily and with high accuracy

In the fuel cell system described above, it is preferable that a temperature sensor configured to measure a temperature of the fuel cell is further included, and that the control unit adjusts a supply amount of the fuel gas to the fuel gas supply flow path such that an increase rate of a detection result by the temperature sensor, which increases due to the control unit issuing the valve opening instructions to both the drain valve and the opening and closing valve or to only the drain valve, is within a prescribed range. For example, in a state where the drain valve is open, the amount of the unconsumed portion contained in the discharged fluid discharged from the liquid discharge port is adjusted when the supply amount (flow rate) of the fuel gas to the fuel gas supply flow path is adjusted. Due to this, the amount of the unconsumed portion supplied to the cathode is adjusted, and therefore the amount of heat generated by the exothermic reaction in the cathode catalyst can be adjusted.

On the other hand, with the opening and closing valve in the open state, the amount of fuel gas supplied to the cathode is adjusted, via the distribution flow path, when the supply amount of the fuel gas to the fuel gas supply flow path is adjusted. Accordingly, in this case as well, the amount of heat generated by the exothermic reaction in the cathode catalyst can be adjusted. In other words, it is possible to heat the fuel cell system with a temperature increase rate that is neither excessive nor insufficient by adjusting the supply amount of the fuel gas such that the increase rate of the temperature of the fuel cell system is within a prescribed range, and therefore it is possible to favorably perform the warm-up of the fuel cell within a desired time.

According to another aspect of the present invention, there is provided a control method of a fuel cell system for generating electric power by supplying fuel gas to an anode of a fuel cell via a fuel gas supply flow path and supplying an oxygen-containing gas to a cathode of the fuel cell via an oxygen-containing gas supply flow path, the control method including a valve opening judgment step of judging whether a drain valve configured to discharge a discharge fluid from a liquid discharge port of a gas-liquid separator has opened correctly in response to valve opening instructions, the gas-liquid separator being configured to separate fuel exhaust gas discharged from the anode into a gas and the liquid, the discharge fluid including the liquid, wherein, in the valve opening judgment step, if it is judged that the drain valve has opened correctly, the discharge fluid is supplied along with the oxygen-containing gas to the cathode to cause an exothermic reaction in the cathode, by continuing to issue the valve open instructions to the drain valve.

In this control method of the fuel cell system, if it is judged that the drain valve has opened correctly in the valve opening judgment step, the unconsumed portion contained in the discharge fluid discharged from the liquid discharge port of the gas-liquid separator is supplied along with the oxygen-containing gas to the cathode. Due to this, it is possible to cause the exothermic reaction in the cathode catalyst. As a result, it is possible to heat the fuel cell using the heat of the exothermic reaction, and therefore the fuel cell can be warmed up quickly. Furthermore, in normal cases, the unconsumed portion contained in the discharge fluid released into the atmosphere or the like can be efficiently utilized, and therefore it is possible to increase the usage efficiency of the fuel gas supplied to the fuel cell system.

In the control method of the fuel cell system described above, it is preferable that, in the valve opening judgment step, if it is judged that the drain valve has not opened correctly, at least one of the fuel gas supplied to the fuel gas supply flow path and discharge gas discharged from a gas discharge port of the gas-liquid separator is supplied along with the oxygen-containing gas to the cathode to cause the exothermic reaction in the cathode. Even in a case where the drain valve does not open correctly, and the fuel gas contained in the discharge fluid cannot be supplied to the cathode, any one of the fuel gas supplied to the fuel gas supply flow path, the discharge gas, and the mixture of these gases is supplied to the cathode, and the exothermic reaction can be caused. Accordingly, it is possible to quickly warm up the fuel cell.

In the control method of the fuel cell system described above, it is preferable that an increase rate checking step of, after the valve opening judgment step, judging whether an increase rate of a temperature of the fuel cell, which was increased by causing the exothermic reaction in the cathode, is within a prescribed range is further included, and that, in the increase rate checking step, if it is judged that the increase rate is not within the prescribed range, a supply amount of the fuel gas to the fuel gas supply flow path is adjusted. By adjusting the supply amount of the fuel gas such that the increase rate of the temperature of the fuel cell system is within a prescribed range, the fuel cell system can be heated with a temperature increase rate that is neither excessive nor insufficient, and therefore the fuel cell can be favorably warmed up in the desired time.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic configurational view of the main components of a fuel cell system according to an embodiment of the present invention.

FIG. 2 is a flow chart describing a control method of the fuel cell system.

### DESCRIPTION OF THE PREFERRED EMBODIMENTS

The following describes examples of preferred embodiments of the fuel cell system and control method thereof according to the present invention, while referencing the accompanying drawings.

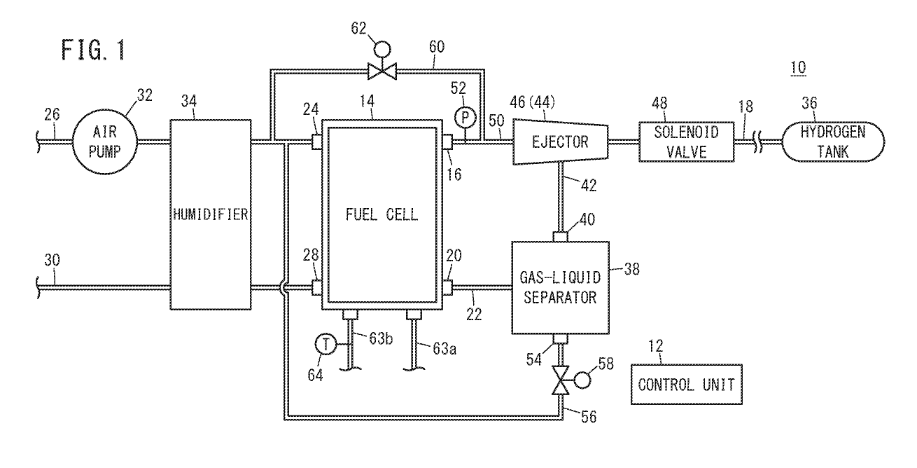

In the present embodiment, an example is described in which a fuel cell system 10 shown in FIG. 1 is mounted in a fuel cell vehicle (not shown in the drawings) such as a fuel cell electric automobile or the like, but the present invention is not particularly limited to this. For example, the fuel cell system 10 can be adopted in various moving bodies other than a fuel cell vehicle, or can be used as a stationary device.

The fuel cell system 10 includes a control unit 12 that controls the fuel cell system 10 and a fuel cell 14 that is formed by a stack in which a plurality of power generation cells, not shown in the drawings, are stacked. Each power generation cell is formed by sandwiching, between a pair of separators, a membrane electrode assembly including an electrolyte membrane made of a solid polymer and an anode and a cathode that sandwich this electrolyte membrane, the anode and the cathode facing each other. Power generation is performed by supplying the anode with fuel gas containing hydrogen and supplying the cathode with oxygen-containing gas that contains oxygen. Since the configuration of a power generation cell is widely known, drawings and a detailed description of the power generation cell are omitted.

In the fuel cell 14, a fuel gas supply flow path 18 for supplying the fuel gas is connected to a fuel gas supply port 16 of the anode, and a fuel exhaust gas flow path 22 for discharging the fuel exhaust gas is connected to a fuel exhaust gas discharge port 20 of the anode. Furthermore, an oxygen-containing gas supply flow path 26 for supplying the oxygen-containing gas is connected to an oxygen-containing gas supply port 24 of the cathode, and an oxygen-containing exhaust gas flow path 30 for discharging the oxygen-containing exhaust gas is connected to an oxygen-containing exhaust gas discharge port 28 of the cathode.

The oxygen-containing gas supply flow path 26 is provided with an air pump 32 and a humidifier 34, in the stated order form the upstream side thereof. By driving the air pump 32, air serving as the oxygen-containing gas is taken into the oxygen-containing gas supply flow path 26 from the atmosphere. This air is compressed by the air pump 32 and then supplied to the humidifier 34. In the humidifier 34, the oxygen-containing gas within the oxygen-containing gas supply flow path 26 and the oxygen-containing exhaust gas within the oxygen-containing exhaust gas flow path 30 are caused to exchange moisture, thereby humidifying the oxygen-containing gas before it is supplied to the cathode.

Hydrogen stored in a hydrogen tank 36 is supplied into the fuel gas supply flow path 18 as the fuel gas. A gas-liquid separator 38 that separates the fuel exhaust gas into a gas and a liquid is connected to the downstream side of the fuel exhaust gas flow path 22. Specifically, fuel exhaust gas containing an unconsumed portion of fuel gas that was not consumed by the anode (referred to below simply as an unconsumed portion), excess water, and the like flows into the gas-liquid separator 38 via the fuel exhaust gas flow path 22. A circulation flow path 42 is connected to a gas discharge port 40 of the gas-liquid separator 38. Therefore, discharge gas containing mainly the unconsumed portion and having its liquid water separated therefrom is discharged from the gas discharge port 40 into the circulation flow path 42.

The downstream side of the circulation flow path 42 is in communication with the fuel gas supply flow path 18, via a connecting section 44. An ejector 46 is provided to the connecting section 44. The ejector 46 is supplied with the fuel gas via a solenoid valve or electromagnetic valve (injector) 48 provided on the upstream side of the ejector 46. Due to this, the ejector 46 mixes together the discharge gas and the fuel gas to create mixed gas, and discharges this mixed gas to the downstream side (mixed gas flow path 50) of the ejector 46 of the fuel gas supply flow path 18.

A pressure sensor 52 is provided in the mixed gas flow path 50. The pressure sensor 52 measures the pressure of circulated gas (mixed gas, fuel exhaust gas, and discharge gas) circulating through the mixed gas flow path 50, the fuel exhaust gas flow path 22, and the circulation flow path 42.

A liquid discharge port 54 of the gas-liquid separator 38 is connected to a connecting flow path 56. The connecting flow path 56 is in communication with the liquid discharge port 54 and the oxygen-containing gas supply flow path 26, via a drain valve 58 for discharging discharge fluid from the liquid discharge port 54. This drain valve 58 is opened and closed with energization.

A gas-liquid separator, not shown in the drawings, may be provided between the downstream side of the drain valve 58 of the connecting flow path 56 and the oxygen-containing gas supply flow path 26. Due to this gas-liquid separator, the discharge fluid flows into the oxygen-containing gas supply flow path 26 in a state where the liquid in this discharge fluid has been separated.

The mixed gas flow path 50 and the oxygen-containing gas supply flow path 26 are in communication with each other due to a distribution flow path 60. An opening and closing valve 62 that opens and closes the distribution flow path 60 is provided in the distribution flow path 60.

In the fuel cell 14, a coolant supply flow path 63a and a coolant discharge flow path 63b for supplying and discharging coolant are disposed in a coolant flow path (not shown in the drawings) provided in the fuel cell 14. In the present embodiment, a temperature sensor 64 is provided in the coolant discharge flow path 63b, and this temperature sensor 64 measures the temperature in the coolant discharge flow path 63b as the temperature of the fuel cell system 10.

The control unit 12 is configured as a microcomputer including a CPU and the like, not shown in the drawings, and this CPU executes prescribed computations in accordance with a control program, to perform various types of processing and control such as normal operation control and warm-up control of the fuel cell system 10. Furthermore, the control unit 12 outputs a control signal such as valve opening instructions or valve closing instructions to each configurational element such as the drain valve 58 or the opening and closing valve 62, based on detection signals received from each of the various sensors such as the pressure sensor 52 or the temperature sensor 64, for example.

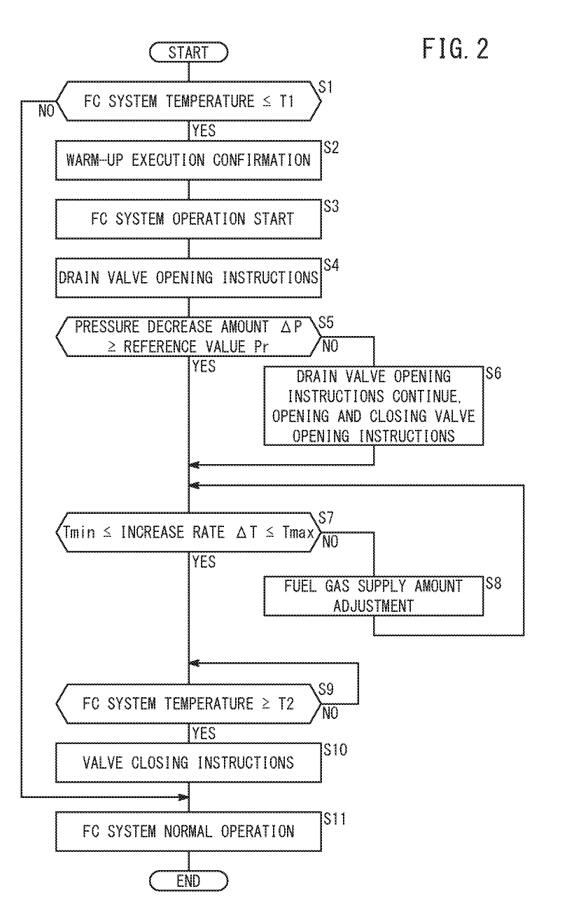

The following describes the control method of the fuel cell system 10 according to the present embodiment, while referencing the flow chart shown in FIG. 2.

First, at step S1, a judgment is made as to whether or not the temperature of the fuel cell system 10 detected by the temperature sensor 64 is less than or equal to a warm-up execution temperature T1 (i.e., whether the temperature of the fuel cell system≤T1). The warm-up execution temperature T1 is not particularly limited as long as it is a temperature judged to be necessary for warm-up of the fuel cell 14, and can be set to be below the freezing point near 0° C., for example.

At step S1, if it is judged that the temperature of the fuel cell system 10 is greater than the warm-up execution temperature T1 (step S1: NO), the fuel cell system 10 begins normal operation without performing a warm-up.

At step S1, if it is judged that the temperature of the fuel cell system 10 is less than or equal to the warm-up execution temperature T1 (step S1: YES), warm-up execution of the fuel cell 14 is confirmed at step S2, and the process proceeds to step S3.

At step S3, operation of the fuel cell system 10 begins. Due to this, the fuel gas is supplied from the hydrogen tank 36 to the fuel gas supply flow path 18, and also the oxygen-containing gas is supplied to the oxygen-containing gas supply flow path 26 due to the rotational effect of the air pump 32. The fuel gas supplied to the fuel gas supply flow path 18 is supplied to the anode through the solenoid valve 48 and the ejector 46. The oxygen-containing gas supplied to the oxygen-containing gas supply flow path 26 is supplied to the cathode, through the humidifier 34.

Due to this, the fuel gas and the oxygen-containing gas are consumed in an electrochemical reaction (power generation reaction) in the anode catalyst of the anode and the cathode catalyst of the cathode, thereby generating electric power. The coolant is supplied from the coolant supply flow path 63a to the coolant flow path of the fuel cell 14. The coolant flows through the coolant flow path, and is then discharged to the coolant discharge flow path 63b.

The oxygen-containing gas that has been supplied to the cathode and had a portion of its oxygen consumed is discharged to the oxygen-containing exhaust gas flow path 30 as the oxygen-containing exhaust gas. This oxygen-containing exhaust gas humidifies oxygen-containing gas to be newly supplied to the cathode, for example, in the humidifier 34, and is thereafter discharged to the outside of the fuel cell system 10.

The unconsumed portion of the fuel gas that was not consumed at the anode is discharged to the fuel exhaust gas flow path 22 as the fuel exhaust gas, and is then introduced into the gas-liquid separator 38. Due to this, the fuel exhaust gas is separated into discharge gas, which is a gas component, and discharge fluid, which is a liquid component. At this time, since the drain valve 58 is in a closed state, the discharge fluid is held on the upstream side of the drain valve 58.

By ejecting the fuel gas from the solenoid valve 48 to the upstream side of the ejector 46 in the manner described above, negative pressure is caused in the circulation flow path 42. Therefore, the discharge gas is sucked into the ejector 46 via the circulation flow path 42 and is mixed with the fuel gas supplied to the fuel gas supply flow path 18. Due to this, the mixed gas is discharged to the mixed gas flow path 50 on the downstream side of the ejector 46.

Accordingly, the unconsumed portion discharged from the anode as the fuel exhaust gas without being consumed in the power generation reaction has its liquid water separated, thereby becoming the discharge gas, and is then mixed with the fuel gas newly supplied to the fuel gas supply flow path 18 to become the mixed gas, which is supplied to the anode once again.

Next, after the valve opening instructions have been issued to the drain valve 58 at step S4, a judgment is made at step S5 as to whether the drain valve 58 has actually opened. In other words, a judgment is made as to whether the drain valve 58 has correctly opened in response to the valve opening instructions (valve opening judgment step).

Specifically, the magnitude of the decrease in the pressure of the circulated gas detected by the pressure sensor 52 (pressure decrease amount ΔP) before and after the valve open instructions were issued to the drain valve 58 is obtained, and a judgment is made as to whether or not this pressure decrease amount ΔP is greater than or equal to a reference value Pr (i.e., whether ΔP≥Pr). The reference value Pr can be set by measuring in advance the pressure of the circulated gas in a state where the drain valve 58 is closed and the pressure of the circulated gas in a state where the drain valve 58 is open, and then setting the difference between these pressures to be the reference value Pr.

At step S5, if the pressure decrease amount ΔP is greater than or equal to the reference value Pr, in other words, if it is judged that the drain valve 58 opened correctly (step S5: YES), the valve opening instructions continue to be issued to the drain valve 58 without change. In this case, since the drain valve 58 is open, the discharge fluid flows to the downstream side of the drain valve 58 in the connecting flow path 56, and the unconsumed portion contained in this discharge fluid is supplied along with the oxygen-containing gas to the cathode. As a result, since an exothermic reaction occurs in the cathode catalyst, the heating of the fuel cell 14 speeds up due to the heat of this exothermic reaction and the heat of the power generation reaction described above.

At step S5, if the pressure decrease amount ΔP is less than the reference value Pr, in other words, if it is judged that the drain valve 58 did not open correctly (step S5: NO), then the process proceeds to step S6, at which the valve opening instructions continue to be issued to the drain valve 58, and valve opening instructions are also issued to the opening and closing valve 62. Due to this, when the opening and closing valve 62 opens, the mixed gas flow path 50 and the oxygen-containing gas supply flow path 26 come into communication with each other via the distribution flow path 60, and therefore the mixed gas flows through the oxygen-containing gas supply flow path 26. As a result, the fuel gas contained in the mixed gas is supplied along with the oxygen-containing gas to the cathode, and the exothermic reaction occurs in the cathode catalyst. Due to this exothermic reaction and the power generation reaction described above, the fuel cell 14 heats up quickly. Next, at step S7, a judgment is made as to whether or not an increase rate ΔT by which the detection result of the temperature sensor 64 increases due to the exothermic reaction and power generation reaction described above is within a range of being greater than or equal to a minimum value Tmin and less than or equal to a maximum value Tmax (Tmin≤ΔT≤Tmax) (increase rate checking step). The minimum value Tmin and the maximum value Tmax should each be set such that the time needed for warm-up of the fuel cell system 10 is within a desired range, for example. At step S7, if it is judged that the increase rate ΔT is not within the range described above (ΔT<Tmin, or Tmax<ΔT) (step S7: NO), the process proceeds to step S8 and the supply amount (flow rate) of the fuel gas to the fuel gas supply flow path 18 is adjusted. For example, if it is judged that ΔT<Tmin, the supply amount of the fuel gas to the fuel gas supply flow path 18 is increased. On the other hand, if it is judged that Tmax<ΔT, the supply amount of the fuel gas to the fuel gas supply flow path 18 is decreased. The processes of steps S7 and S8 are performed repeatedly, until the increase rate ΔT falls within the range described above.

At step S7, if it is judged that the increase rate AT is within the range described above (step S7: YES), the process moves to step S9. At step S9, a judgment is made as to whether or not the temperature of the fuel cell system 10 detected by the temperature sensor 64 is greater than or equal to a warm-up completion temperature T2 (i.e., whether the temperature of the fuel cell system T2). The warm-up completion temperature T2 is a temperature at which the warm-up of the fuel cell 14 is judged to be completed, and can be set to be 60° C., for example.

At step S9, if it is judged that the temperature of the fuel cell system 10 is less than the warm-up completion temperature T2 (step S9: NO), the process of step S9 is repeated until the temperature of the fuel cell system 10 becomes greater than or equal to the warm-up completion temperature T2.

At step S9, if it is judged that the temperature of the fuel cell system 10 is greater than or equal to the warm-up completion temperature T2 (step S9: YES), the process proceeds to step S10. At step S10, if valve opening instructions have been issued to both the drain valve 58 and the opening and closing valve 62 in the processing up to this point, valve closing instructions are issued to the drain valve 58 and the opening and closing valve 62. On the other hand, if valve opening instructions were issued to only the drain valve 58, valve closing instructions are issued to the drain valve 58. By closing the drain valve 58 with these valve closing instructions, the supply of the discharge fluid to the cathode is stopped. Furthermore, by closing the opening and closing valve 62, the supply of the mixed gas to the cathode is stopped.

Next, at step S11, the normal operation of the fuel cell system 10 begins. After the process of step S11, the flow chart according to the present embodiment is ended.

As described above, with the fuel cell system 10 and control method thereof according to the present embodiment, if the drain valve 58 opens correctly in response to the valve opening instructions when the warm-up of the fuel cell 14 begins, the unconsumed portion contained in the discharge fluid flows into the oxygen-containing gas supply flow path 26 via the connecting flow path 56. Due to this, the unconsumed portion contained in the discharge fluid is supplied along with the oxygen-containing gas to the cathode, and the exothermic reaction in the cathode catalyst can be caused.

Accordingly, since the fuel cell 14 can be heated by the heat of the exothermic reaction in the cathode catalyst as well as by the heat of the power generation reaction of the fuel cell 14, it is possible to quickly warm up the fuel cell 14. Furthermore, in normal cases, the unconsumed portion contained in the discharge fluid released into the atmosphere or the like can be efficiently utilized, and therefore it is possible to increase the usage efficiency of the fuel gas supplied to the fuel cell system 10. In this case, it is also possible to remove the need for equipment for diluting the unconsumed portion contained in the discharge fluid, or the like.

On the other hand, if the drain valve 58 does not open correctly despite the valve opening instructions being issued when the warm-up of the fuel cell 14 begins, the opening and closing valve 62 is opened and the mixed gas flows into the oxygen-containing gas supply flow path 26 via the distribution flow path 60. Due to this, the fuel gas contained in the mixed gas, instead of the discharge fluid, is supplied along with the oxygen-containing gas to the cathode, and it is possible to cause the exothermic reaction in the cathode catalyst.

Accordingly, even in a case where the drain valve 58 does not open correctly due to freezing or the like, for example, and the unconsumed portion contained in the discharge fluid cannot be supplied to the cathode, it is possible to quickly warm up the fuel cell 14.

As described above, the ejector 46 is provided in the connecting section 44 between the fuel gas supply flow path 18 and the circulation flow path 42, and the fuel gas is supplied to this ejector 46 via the solenoid valve 48. Furthermore, the distribution flow path 60 forms communication between the oxygen-containing gas supply flow path 26 and the mixed gas flow path 50, which is farther downstream than the ejector 46 of the fuel gas supply flow path 18.

In this case, when the opening and closing valve 62 is opened, the mixed gas on the downstream side of the ejector 46 flows through the connecting flow path 56 via the distribution flow path 60, and therefore the solenoid valve 48 provided on the upstream side of the ejector 46 increases the flow rate of the fuel gas ejected into this ejector 46. Due to this, the suction force exerted on the discharge gas by the ejector 46 also increases, and the circulation efficiency of the circulated gas can be improved without using a pump or the like. As a result, the power generation reaction is encouraged with a simple configuration, and the warm-up of the fuel cell 14 can be performed quickly. As described above, in the valve opening judgment step, the judgment as to whether the drain valve 58 is open is based on the detection results of the pressure sensor 52 before and after the valve opening instructions are issued to the drain valve 58. In this way, by basing this judgment on the detection results of the pressure sensor 52, it is possible for the judgment as to whether the drain valve 58 is actually open to be made easily and with high accuracy.

As described above, if the increase rate checking step of step S7 is performed after step S5 without performing step S6, in other words, if the drain valve 58 is in the open state, the amount of the unconsumed portion contained in the discharged fluid is adjusted when the supply amount (flow rate) of the fuel gas to the fuel gas supply flow path 18 is adjusted. Due to this, the amount of the unconsumed portion supplied to the cathode is adjusted, and therefore the amount of heat generated by the exothermic reaction in the cathode catalyst can be adjusted.

On the other hand, if the increase rate checking step of step S7 is performed after step S5 with step S6 performed therebetween, in other words, if the opening and closing valve 62 is in the open state, the amount of fuel gas supplied to the cathode is adjusted, via the distribution flow path 60, when the supply amount of the fuel gas to the fuel gas supply flow path 18 is adjusted. Accordingly, in this case as well, the amount of heat generated by the exothermic reaction in the cathode catalyst can be adjusted.

In other words, as described above, it is possible to heat the fuel cell system 10 with a temperature increase rate that is neither excessive nor insufficient by adjusting the supply amount of the fuel gas such that the increase rate ΔT of the temperature of the fuel cell system 10 is within a prescribed range, and therefore it is possible to favorably perform the warm-up of the fuel cell 14 within a desired time.

The present invention is not limited to the embodiments described above, and various alterations can be made without deviating from the scope of the present invention.

For example, in the fuel cell system 10 according to the embodiment described above, the mixed gas is distributed to the oxygen-containing gas supply flow path 26 by causing the mixed gas flow path 50 and the oxygen-containing gas supply flow path 26 to be in communication through the distribution flow path 60 and opening the opening and closing valve 62. However, the distribution flow path 60 may cause the circulation flow path 42 and the oxygen-containing gas supply flow path 26 to be in communication with each other. In this case, it is possible to supply the discharge gas to the cathode and cause the exothermic reaction in the cathode catalyst by opening the opening and closing valve 62. Furthermore, the distribution flow path 60 may cause the oxygen-containing gas supply flow path 26 to be in communication with a portion of the fuel gas supply flow path 18 farther upstream than the ejector 46. In this case, it is possible to supply the cathode with the fuel gas supplied to the fuel gas supply flow path 18 and cause the exothermic reaction in the cathode catalyst by opening the opening and closing valve 62.

In the embodiment described above, the temperature sensor 64 is provided in the coolant discharge flow path 63b, and the temperature sensor 64 measures the temperature of the coolant discharge flow path 63b as the temperature of the fuel cell system 10. However, as long as it is possible to measure the temperature of the fuel cell system 10, the location where the temperature sensor 64 is provided is not particularly limited. Similarly, the location where the pressure sensor 52 is installed is not limited to the mixed gas flow path 50, as long as the pressure sensor 52 is provided at a location enabling detection of the pressure of the mixed gas.

In the embodiment described above, the ejector 46 is provided to the connecting section 44, but the present invention is not particularly limited to this. For example, instead of provided the ejector 46, a pump or the like, not shown in the drawings, may be provided to the circulation flow path 42 to circulate the circulated gas.

What is claimed is:

1. A fuel cell system for generating electric power by supplying fuel gas to an anode of a fuel cell via a fuel gas supply flow path and supplying an oxygen-containing gas to a cathode of the fuel cell via an oxygen-containing gas supply flow path, the fuel cell system comprising:
a fuel exhaust gas flow path configured to allow fuel exhaust gas discharged from the anode to flow therethrough;
a gas-liquid separator into which the fuel exhaust gas flows via the fuel exhaust gas flow path, the gas-liquid separator being configured to separate the fuel exhaust gas into a gas and a liquid;
a circulation flow path that is connected to the fuel gas supply flow path via a connecting section so as to cause a gas discharge port of the gas-liquid separator and the fuel gas supply flow path to be in communication with each other;
a connecting flow path configured to cause a liquid discharge port of the gas-liquid separator to be in communication with the oxygen-containing gas supply flow path, via a drain valve;
a distribution flow path configured to cause the fuel gas supply flow path or the circulation flow path to be in communication with the oxygen-containing gas supply flow path; and
an opening and closing valve configured to open and close the distribution flow path.

2. The fuel cell system according to claim 1, wherein
the connecting section is provided with an ejector configured to mix together the fuel gas supplied to the fuel gas supply flow path and discharge gas discharged from the gas discharge port to the circulation flow path,
the ejector is supplied with the fuel gas via a solenoid valve, and
the distribution flow path causes a portion of the fuel gas supply flow path farther downstream than the ejector to be in communication with the oxygen-containing gas supply flow path.

3. The fuel cell system according to claim 1, further comprising:
a control unit configured to issue valve opening instructions or valve closing instructions to the opening and closing valve and the drain valve, wherein
the control unit issues the valve opening instructions to the drain valve when a warm-up of the fuel cell begins.

4. The fuel cell system according to claim 3, wherein
the control unit issues the valve opening instructions to the opening and closing valve if it is judged that the drain valve to which the valve opening instructions have been issued is not open.

5. The fuel cell system according to claim 4, further comprising:
a pressure sensor configured to detect pressure of gas circulating through a portion of the fuel gas supply flow path farther downstream than the connecting section, the fuel exhaust gas flow path, and the circulation flow path, wherein
the control unit judges whether the drain valve to which the valve opening instructions have been issued is open, based on a detection result of the pressure sensor.

6. The fuel cell system according to claim 4, further comprising:
a temperature sensor configured to measure a temperature of the fuel cell, wherein
the control unit adjusts a supply amount of the fuel gas to the fuel gas supply flow path so that an increase rate of a detection result by the temperature sensor, which increases due to the control unit issuing the valve opening instructions to both the drain valve and the opening and closing valve or to only the drain valve, is within a prescribed range.

7. A control method of a fuel cell system for generating electric power by supplying fuel gas to an anode of a fuel cell via a fuel gas supply flow path and supplying an oxygen-containing gas to a cathode of the fuel cell via an oxygen-containing gas supply flow path, the control method comprising:
a valve opening judgment step of judging whether a drain valve configured to discharge a discharge fluid from a liquid discharge port of a gas-liquid separator has opened correctly in response to valve opening instructions, the gas-liquid separator being configured to separate fuel exhaust gas discharged from the anode into a gas and a liquid, the discharge fluid including the liquid, wherein
in the valve opening judgment step, if it is judged that the drain valve has opened correctly, the discharge fluid is supplied along with the oxygen-containing gas to the cathode to cause an exothermic reaction in the cathode, by continuing to issue the valve open instructions to the drain valve.

8. The control method of the fuel cell system according to claim 7, wherein
in the valve opening judgment step, if it is judged that the drain valve has not opened correctly, at least one of the fuel gas supplied to the fuel gas supply flow path and discharge gas discharged from a gas discharge port of the gas-liquid separator is supplied along with the oxygen-containing gas to the cathode to cause the exothermic reaction in the cathode.

9. The control method of the fuel cell system according to claim 8, further comprising:
an increase rate checking step of, after the valve opening judgment step, judging whether an increase rate of a temperature of the fuel cell, which was increased by causing the exothermic reaction in the cathode, is within a prescribed range, wherein
in the increase rate checking step, if it is judged that the increase rate is not within the prescribed range, a supply amount of the fuel gas to the fuel gas supply flow path is adjusted.
